(19) United States
(12) Patent Application Publication
(10) Pub. No.: US 2025/0229731 A1
(43) Pub. Date: Jul. 17, 2025

(54) GARNISH PANEL WITH SPLIT REINFORCING RIBS

(71) Applicant: Honda Motor Co., Ltd., Tokyo (JP)

(72) Inventors: Patrick W. KRUSE, Marysville, OH (US); David J. ROSE, West Mansfield, OH (US); Jeffrey D. WHEELAND, Radnor, OH (US); Hirofumi TAKEMOTO, Dublin, OH (US)

(21) Appl. No.: 18/414,871

(22) Filed: Jan. 17, 2024

(51) Int. Cl. B60R 13/04; B60R 13/07

(52) U.S. Cl. CPC B60R 13/04; B60R 13/07

(57) ABSTRACT

A garnish panel for a vehicle including a substantially flat surface configured to face a vehicle upon which the garnish panel is to be mounted; the substantially flat surface extending in a direction configured to be oriented substantially vertically when the garnish is mounted on the vehicle; the substantially flat surface including a first lateral edge and a second lateral edge; and the garnish panel including a plurality of reinforcing ribs extending discontinuously across the substantially flat surface from the first lateral edge to the second lateral edge.

### BACKGROUND

### 1. Field of the Disclosure

The present disclosure relates to an automotive garnish panel with a water drainage feature and, more particularly, to a garnish panel with split reinforcing ribs.

### 2. Description of Related Art

Many automobiles and other motorized vehicles include panels that enhance the appearance and/or functionality of the vehicle body. These panels are referred to as garnish panels or simply “garnishes.” Garnishes are often placed at the edges of body panels, for example adjacent windows. There are typically one or more small spaces between a garnish and the body of the vehicle. Accordingly, water can collect between the garnish and the body of the vehicle. Some garnishes include reinforcing ribs that can impede the flow of water, thereby leading to poor drainage. For garnish panels associated with D-pillars, the water can collect behind the garnish on the ribs, only to spill out onto the car's owner upon opening the rear hatch.

There is a need in the art for a garnish configuration that addresses one or more of the issues noted above.

### SUMMARY OF THE INVENTION

The present disclosure directed to a garnish panel with ribs configured to improve drainage from behind the garnish. In order to provide both reinforcement and improved drainage, the ribs may be split or discontinuous across the surface of the garnish panel that faces the body of the vehicle.

In one aspect, the present disclosure is directed to a garnish panel for a vehicle, comprising: a substantially flat surface configured to face a vehicle upon which the garnish panel is to be mounted; the substantially flat surface extending in a direction configured to be oriented substantially vertically when the garnish is mounted on the vehicle; the substantially flat surface including a first lateral edge and a second lateral edge; and the garnish panel including a plurality of reinforcing ribs extending discontinuously across the substantially flat surface from the first lateral edge to the second lateral edge.

In another aspect, the present disclosure is directed to a garnish panel arrangement for a vehicle. The garnish panel arrangement includes a gutter having a substantially U-shaped cross section and configured to be mounted on a vehicle; and a garnish panel configured to be mounted within the gutter. The garnish panel may include a substantially flat surface configured to face a vehicle upon which the garnish panel is to be mounted; the substantially flat surface extending in a direction configured to be oriented substantially vertically when the garnish is mounted on the vehicle; the substantially flat surface including a first lateral edge and a second lateral edge; and the garnish panel including a plurality of reinforcing ribs extending discontinuously across the substantially flat surface from the first lateral edge to the second lateral edge.

In another aspect, the present disclosure is directed to a vehicle. The vehicle may include a vehicle body defining a structural periphery of the vehicle; and a garnish panel arrangement. The garnish panel arrangement may include a garnish panel configured to be mounted on the vehicle body. The garnish panel may include a substantially flat surface configured to face a vehicle upon which the garnish panel is to be mounted; the substantially flat surface extending in a direction configured to be oriented substantially vertically when the garnish is mounted on the vehicle; the substantially flat surface including a first lateral edge and a second lateral edge; and the garnish panel including a plurality of reinforcing ribs extending discontinuously across the substantially flat surface from the first lateral edge to the second lateral edge.

Other systems, methods, features and advantages of the disclosure will be, or will become, apparent to one of ordinary skill in the art upon examination of the following figures and detailed description. It is intended that all such additional systems, methods, features and advantages be included within this description and this summary, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a schematic rear view of a vehicle including a D-pillar garnish;

FIG. 2 is a schematic left side view of the vehicle shown in FIG. 1;

FIG. 3 is a schematic left side exploded view showing placement of a D-pillar garnish;

FIG. 4 is a schematic rear perspective exploded view showing placement of a D-pillar garnish;

FIG. 5 is a schematic perspective view of a prior art D-pillar garnish;

FIG. 6 is a schematic perspective view of a D-pillar garnish according to an exemplary disclosed embodiment;

FIG. 7 is a schematic front side view of the prior art D-pillar garnish of FIG. 5;

FIG. 8 is a schematic cross-sectional view of the prior art D-pillar garnish of FIG. 5 taken at line 8-8 in FIG. 7;

FIG. 9 is a schematic front side view of the prior art D-pillar garnish of FIG. 6; and

FIG. 10 is a schematic cross-sectional view of the D-pillar garnish of FIG. 6 taken at line 10-10 in FIG. 9.

### DETAILED DESCRIPTION

According to some aspects, the present disclosure is directed to a vehicle. The vehicle may include a vehicle body defining a structural periphery of the vehicle. As shown in the accompanying figures and discussed in greater detail below, the vehicle may include a garnish panel configured to be mounted on the vehicle body. The garnish panel may be configured to be mounted on any suitable portion of the vehicle body. For example, in some embodiments, the garnish panel is configured to be mounted in a D-pillar region of the vehicle body. A D-pillar of a vehicle is a known region of a vehicle body extending between a quarter window and a tailgate of a four-door vehicle with a rear hatch. Exemplary such vehicles may include Sport Utility Vehicles (SUV's), wagons, cross-overs, minivans, and other vehicles of similar constructions.

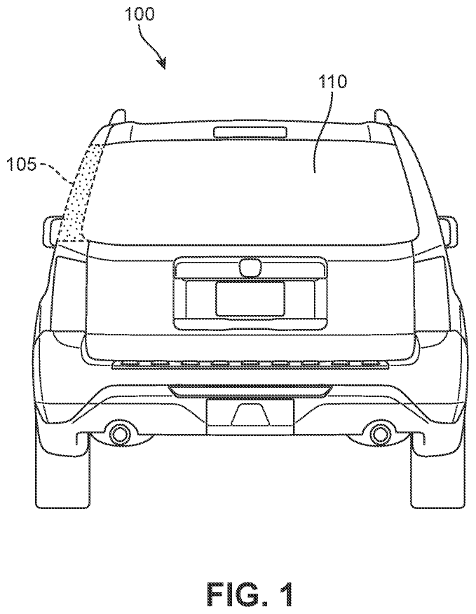

FIG. 1 is a schematic rear view of a vehicle including a D-pillar garnish. As shown in FIG. 1, a vehicle 100 may include a D-pillar garnish 105. D-pillar garnish may be located proximate a rear hatch window 110 of vehicle 100.

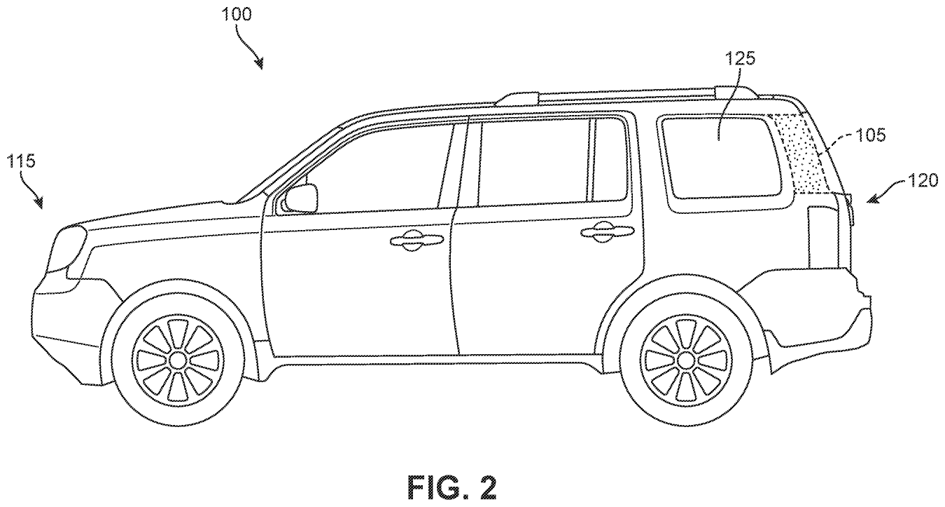

FIG. 2 is a schematic left side view of the vehicle shown in FIG. 1. As shown in FIG. 2, vehicle 100 has a front end 115 and a rear end 120. D-pillar garnish 105 is located toward rear end 120 of vehicle 100 proximate rear quarter window 125.

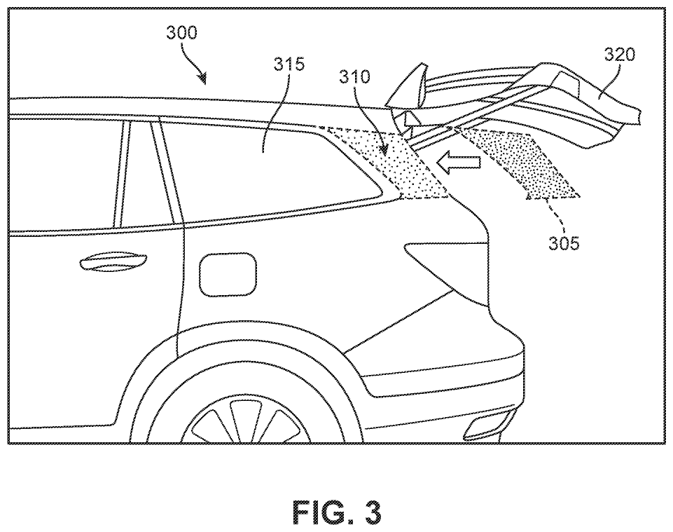

FIG. 3 is a schematic left side exploded view showing placement of a D-pillar garnish. As shown in FIG. 3, a vehicle 300 includes a D-pillar garnish 305 configured to be mounted to the body of vehicle 300 on a D-pillar 310, which is located between a rear quarter window 315 and a rear hatch 320.

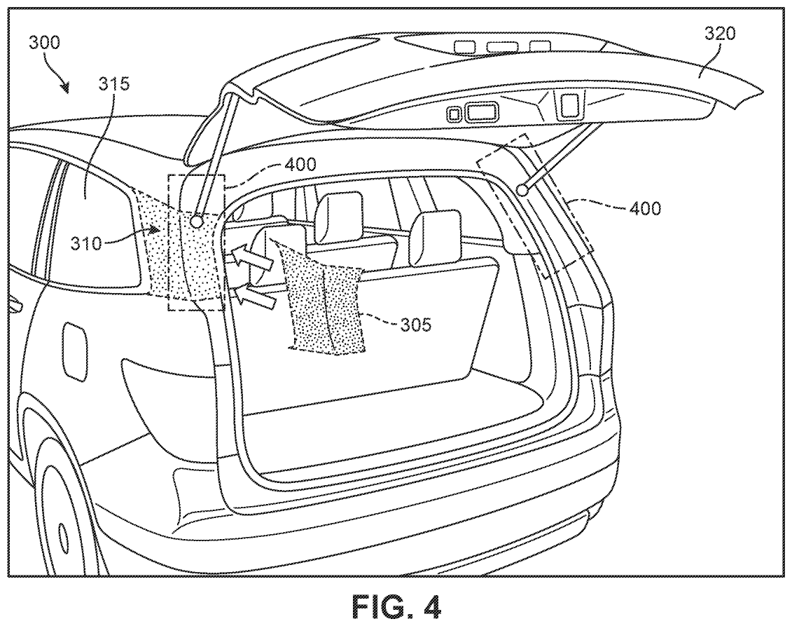

FIG. 4 is a schematic rear perspective exploded view of the vehicle illustrated in FIG. 3, showing placement of a D-pillar garnish. As shown in FIG. 4, gutters 400 may be located adjacent rear hatch 320, and garnish panels, such as D-pillar garnish 305, may be mounted in gutters 400.

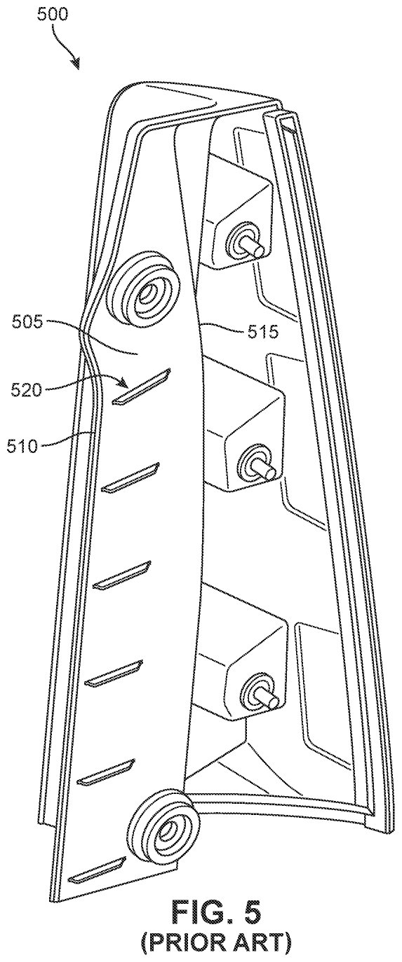

FIG. 5 is a schematic perspective view of a prior art D-pillar garnish. As shown in FIG. 5, a prior art garnish panel 500 is shown in perspective with a body-facing surface 505 visible. Surface 505 is configured to face the body of a vehicle upon which garnish panel 500 may be mounted. Surface 505 extends in a generally vertical direction and spans from a first edge 510 to a second edge 515.

Prior art garnish panel 500 includes a plurality of reinforcing ribs 520 that extend across body-facing surface 505 from first edge 510 toward second edge 515 such that reinforcing ribs 520 extend a substantial majority of the distance across surface 505. Because reinforcing ribs 520 extend a substantial majority of the distance across surface 505, there is a tendency for water to become trapped on reinforcing ribs 520. In embodiments in which garnish panel 500 is a D-pillar garnish (as shown in FIG. 5), trapped water may spill out upon opening a rear hatch of the vehicle.

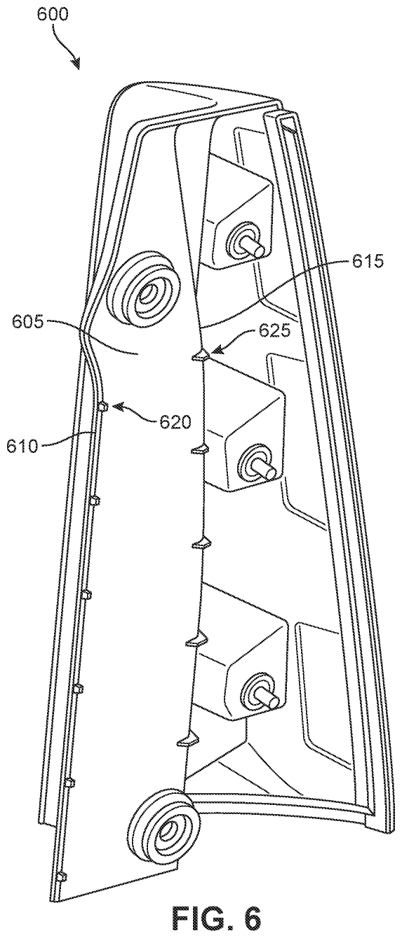

FIG. 6 is a schematic perspective view of a D-pillar garnish according to an exemplary disclosed embodiment. As shown in FIG. 6, a garnish panel 600 is illustrated with a substantially flat, body-facing surface 605 exposed. Surface 605 is configured to face a vehicle upon which the garnish panel is to be mounted. Surface 605 extends in a direction configured to be oriented substantially vertically when garnish panel 600 is mounted on a vehicle. In addition, surface 605 includes a first lateral edge 610 and a second lateral edge 615. Further, garnish panel 600 includes a plurality of reinforcing ribs extending discontinuously across surface 605 from first lateral edge 610 to second lateral edge 615. As shown in FIG. 6, each of the discontinuous reinforcing ribs includes a first portion 620 extending a first distance from first lateral edge 610 of surface 605 and a second portion 625 extending a second distance from second lateral edge 615 of surface 605. As further shown in FIG. 6, the second distance is greater than the first distance, with second lateral edge 615 being disposed substantially along a lateral midline of garnish panel 600. This provides greater reinforcement proximate the midline of garnish panel 600 and greater drainage proximate the lateral edge of garnish panel 600 where water is more likely to seep between garnish panel 600 and the body of a vehicle on which garnish panel 600 is mounted.

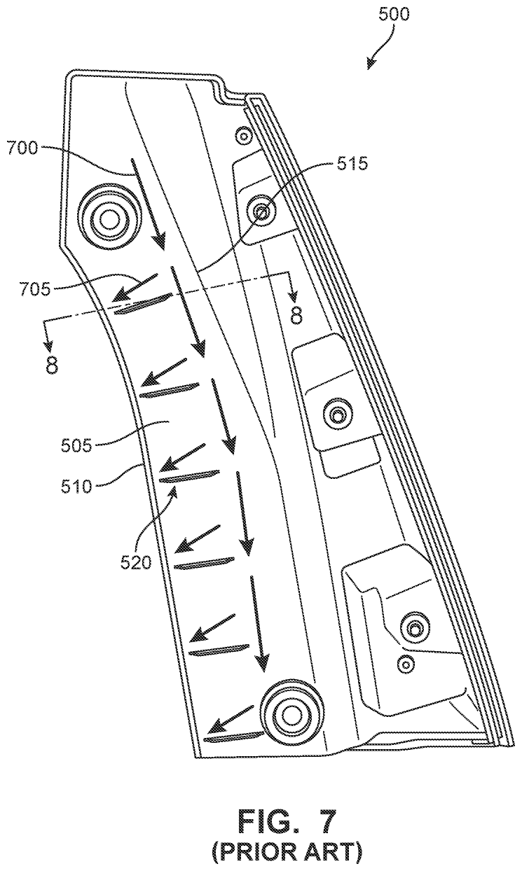

FIG. 7 is a schematic front side view of the prior art D-pillar garnish of FIG. 5. As shown in FIG. 7, garnish panel 500 includes reinforcing ribs 520 disposed on body-facing surface 505. As further shown in FIG. 7, reinforcing ribs 520 extend across a substantial majority of the width of (i.e., more than halfway across) surface 505. Because reinforcing ribs 520 extend less than the full width of surface 505, a narrow substantially vertical channel is defined, through which water may flow in a direction indicated by arrows 700. As water flows downward, some of the water is caught up by reinforcing ribs 520, as indicated by arrows 705. As discussed above, this water collects behind prior art garnish panel 500 and the body of a vehicle.

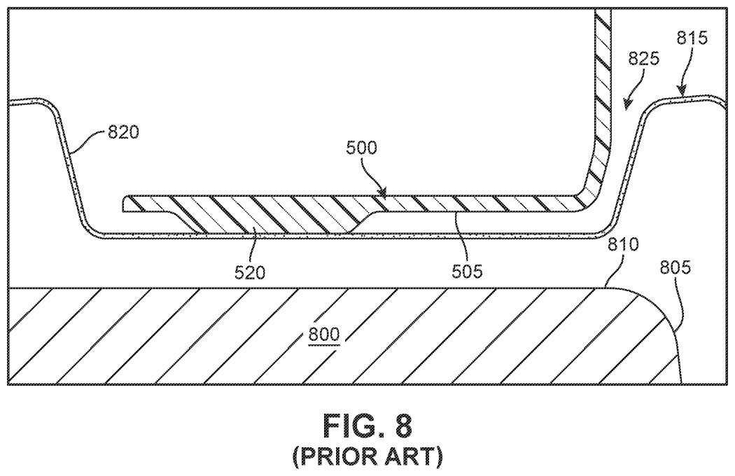

FIG. 8 is a schematic cross-sectional view of the prior art D-pillar garnish of FIG. 5 taken at line 8-8 in FIG. 7. As shown in FIG. 8, prior art garnish panel 500 may be mounted on a body 800 of a vehicle. For context, vehicle body 800 includes a side surface 805 and a rear-facing surface 810.

In some embodiments, garnish panel 500 may be installed in a gutter 815, which may in turn be mounted on vehicle body 800. Gutter 815 may have a substantially U-shaped cross section, with an inner surface 820 defining a cavity 825 in which garnish panel 500 may be installed.

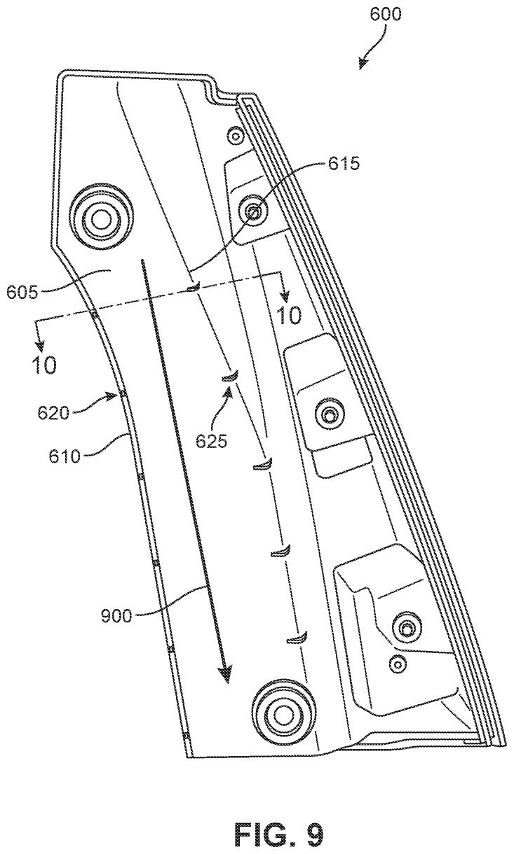

FIG. 9 is a schematic front side view of the prior art D-pillar garnish of FIG. 6. As shown in FIG. 9, garnish panel 600 includes discontinuous reinforcing ribs including first rib portions 620 and second rib portions 625. As further shown in FIG. 9, the discontinuity of the reinforcing ribs defines a substantially vertically oriented water drainage channel, through which water may flow in a direction indicated by an arrow 900. In some embodiments, the vertically oriented water drainage channel extends from a top portion of the garnish panel to a bottom portion of the garnish panel, as shown in FIG. 9.

As further shown in FIG. 9, garnish panel 600 may include five or more discontinuous reinforcing ribs. It will be understood that any suitable number of discontinuous reinforcing ribs may be implemented on a given garnish panel.

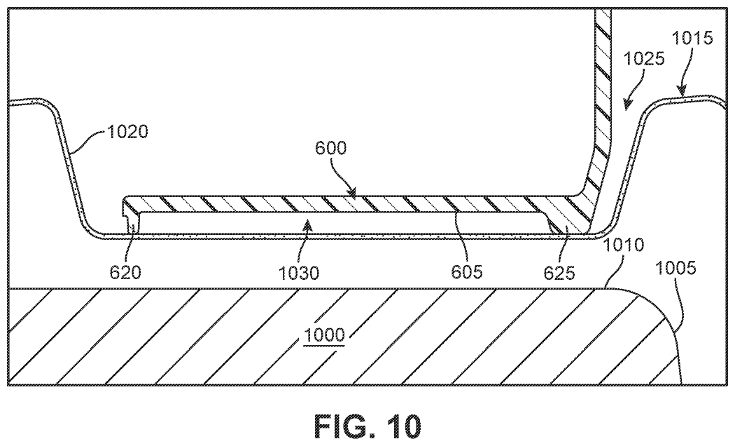

FIG. 10 is a schematic cross-sectional view of the D-pillar garnish of FIG. 6 taken at line 10-10 in FIG. 9. As shown in FIG. 10, garnish panel 600 may be mounted on a body 1000 of a vehicle. For context, vehicle body 1000 includes a side surface 1005 and a rear-facing surface 1010.

In some embodiments, a garnish panel arrangement may include a garnish panel and a gutter, which may be mounted on the vehicle and in which the garnish panel may be installed. For example, as shown in FIG. 10, garnish panel 600 may be installed in a gutter 1015, which may in turn be mounted on vehicle body 1000. Gutter 1015 may have a substantially U-shaped cross section, with an inner surface 1020 defining a cavity 1025 in which garnish panel 600 may be installed.

As further shown in FIG. 10, the discontinuous reinforcing ribs each include a first portion 620 and a second portion 625. Between first portion 620 and second portion 625 a water channel 1030 is defined.

While various embodiments have been described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with, or substituted for, any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

We claim:

1. A garnish panel for a vehicle, comprising:
a substantially flat surface configured to face a vehicle upon which the garnish panel is to be mounted;
the substantially flat surface extending in a direction configured to be oriented substantially vertically when the garnish is mounted on the vehicle;
the substantially flat surface including a first lateral edge and a second lateral edge; and
the garnish panel including a plurality of reinforcing ribs extending discontinuously across the substantially flat surface from the first lateral edge to the second lateral edge.

2. The garnish panel of claim 1, wherein each discontinuous reinforcing rib includes a first portion extending a first distance from the first lateral edge of the substantially flat surface and a second portion extending a second distance from the second lateral edge of the substantially flat surface.

3. The garnish panel of claim 2, wherein the second distance is greater than the first distance.

4. The garnish panel of claim 3, wherein the second lateral edge is disposed substantially along a lateral midline of the garnish panel.

5. The garnish panel of claim 1, wherein the discontinuity of the reinforcing ribs defines a substantially vertically oriented water drainage channel.

6. The garnish panel of claim 5, wherein the vertically oriented water drainage channel extends from a top portion of the garnish panel to a bottom portion of the garnish panel.

7. The garnish panel of claim 1, wherein the plurality of discontinuous reinforcing ribs includes five or more discontinuous reinforcing ribs.

8. A garnish panel arrangement for a vehicle, comprising:
a gutter having a substantially U-shaped cross section and configured to be mounted on a vehicle;
a garnish panel configured to be mounted within the gutter, the garnish panel including:
a substantially flat surface configured to face a vehicle upon which the garnish panel is to be mounted;
the substantially flat surface extending in a direction configured to be oriented substantially vertically when the garnish is mounted on the vehicle;
the substantially flat surface including a first lateral edge and a second lateral edge; and
the garnish panel including a plurality of reinforcing ribs extending discontinuously across the substantially flat surface from the first lateral edge to the second lateral edge.

9. The garnish panel arrangement of claim 8, wherein each discontinuous reinforcing rib includes a first portion extending a first distance from the first lateral edge of the substantially flat surface and a second portion extending a second distance from the second lateral edge of the substantially flat surface.

10. The garnish panel arrangement of claim 9, wherein the second distance is greater than the first distance.

11. The garnish panel arrangement of claim 10, wherein the second lateral edge is disposed substantially along a lateral midline of the garnish panel.

12. The garnish panel arrangement of claim 8, wherein the discontinuity of the reinforcing ribs defines a substantially vertically oriented water drainage channel.

13. The garnish panel arrangement of claim 12, wherein the vertically oriented water drainage channel extends from a top portion of the garnish panel to a bottom portion of the garnish panel.

14. A vehicle, comprising:
a vehicle body defining a structural periphery of the vehicle; and
a garnish panel arrangement, including:
a garnish panel configured to be mounted on the vehicle body;
the garnish panel including:
a substantially flat surface configured to face a vehicle upon which the garnish panel is to be mounted;
the substantially flat surface extending in a direction configured to be oriented substantially vertically when the garnish is mounted on the vehicle;
the substantially flat surface including a first lateral edge and a second lateral edge; and
the garnish panel including a plurality of reinforcing ribs extending discontinuously across the substantially flat surface from the first lateral edge to the second lateral edge.

15. The vehicle of claim 14, wherein each discontinuous reinforcing rib includes a first portion extending a first distance from the first lateral edge of the substantially flat surface and a second portion extending a second distance from the second lateral edge of the substantially flat surface.

16. The vehicle of claim 15, wherein the second distance is greater than the first distance.

17. The vehicle of claim 16, wherein the second lateral edge is disposed substantially along a lateral midline of the garnish panel.

18. The vehicle of claim 14, wherein the discontinuity of the reinforcing ribs defines a substantially vertically oriented water drainage channel.

19. The vehicle of claim 18, wherein the vertically oriented water drainage channel extends from a top portion of the garnish panel to a bottom portion of the garnish panel.

20. The vehicle of claim 14, wherein the plurality of discontinuous reinforcing ribs includes five or more discontinuous reinforcing ribs.
